(19) United States
(12) Patent Application Publication
(10) Pub. No.: US 2026/0078249 A1
(43) Pub. Date: Mar. 19, 2026

(54) PLASTICIZER COMPOSITIONS COMPRISING DEHT AND EPOXIDIZED VEGETABLE OILS, PLASTICIZED COMPOSITIONS COMPRISING THE SAME, FILMS COMPRISING THE SAME, AND BAGS MANUFACTURED FROM FILMS COMPRISING THE SAME

(71) Applicants: BAXTER INTERNATIONAL INC., Deerfield, IL (US); BAXTER HEALTHCARE SA, Glattpark (Opfikon) (CH)

(72) Inventors: Sumana Roychowdhury, Bangalore (IN); Bharath Ns, Mysore (IN); Pushpa Yadav, Ghazipur (IN); Julien Beauquet, Villeneuve D’ascq (FR); Rishi Raj, Patna, Bihar (IN); Amerjit, Mau, Uttar Pradesh (IN); Suryasarathi Bose, Bangalore, Karnataka (IN)

(21) Appl. No.: 18/997,534

(22) PCT Filed: Jul. 17, 2023
(86) PCT No.: PCT/US23/27885

§ 371 Date: Jan. 22, 2025

(30) Foreign Application Priority Data
Jul. 22, 2022 (IN) 202241042069

(51) Int. Cl. C08L 27/06; C08J 5/18; C08K 5/098; C08K 5/12; C08K 5/1515

(52) U.S. Cl. CPC C08L 27/06; C08J 5/18; C08K 5/098; C08K 5/12; C08K 5/1515; C08J 2327/06; C08J 2423/12; C08J 2471/02; C08K 2201/019; C08L 2203/02; C08L 2203/162; C08L 2205/03; C08L 2205/06

(57) ABSTRACT

The invention relates to plasticizer compositions comprising dioctyl terephthalate and epoxidized vegetable oils, plasticized compositions comprising the same, and particularly to bags formed from plasticized compositions including polyvinyl chloride comprising the same, which may be used for IV infusion, peritoneal dialysis, and the like.

### FIELD

The invention relates to plasticizer compositions comprising a combination of dioctyl terephthalate and an epoxidized vegetable oil, plasticized compositions comprising the same, films, and particularly to bags formed from such plasticized compositions, which may be used for IV infusion, blood transfusions, peritoneal dialysis, and the like.

### BACKGROUND

Plasticizers are commonly used in the polymer field to improve the mechanical properties of plastics. Phthalates such as di-ethylhexyl phthalate (DEHP) represent a large group of plasticizers that are commonly used to plasticize a number of plastics including but not limited to thermoplastics such as polyvinyl chloride (PVC). DEHP-plasticized, PVC-containing compositions can be manufactured into a variety of products, including but not limited to bags for medical use.

However, these phthalate plasticizers can present risks to the environment and to public health. For example, DEHP has been shown to leach out of PVC posing risks to the environment and public health. Exposure can lead to potentially heightened health risks which are more pronounced for individuals who frequently receive medications or fluids from bags comprising DEHP-containing plastics. As a result, it would be advantageous to provide DEHP-free plasticizer compositions and particularly DEHP-free plasticized compositions.

### SUMMARY

A plasticized composition comprising a thermoplastic polymer and a combination of plasticizers comprising dioctyl terephthalate (DEHT) and epoxidized linseed oil, wherein the concentration of the epoxidized linseed oil is in the range of about 1.75 to about 6.0 wt %, about 2.0 to about 5.5 wt %, about 2.5 to about 5.0 wt %, and/or about 3.0 to about 4.5 wt % and the total concentration of dioctyl terephthalate and epoxidized linseed oil is in the range of about 23.75 to about 34 wt %, about 25 to about 32.5 wt. %, about 27 to about 31 wt. %, and/or about 27.5 to about 30.5 wt %, based on the total weight of the plasticized composition is disclosed.

Also disclosed is a plasticized composition comprising a thermoplastic polymer and a combination of plasticizers comprising dioctyl terephthalate (DEHT) and epoxidized soybean oil, wherein the concentration of the epoxidized soybean oil is in the range of range of about 0.5 to about 3.0 wt %, about 1.0 to about 2.0 wt %, and/or about 1.25 to about 1.75 wt % and the total concentration of dioctyl terephthalate and epoxidized soybean oil is in the range of about 25.5 to about 33 wt %, about 26 to about 31 wt %, and/or about 27 to about 30 wt %, based on the total weight of the plasticized composition.

### BRIEF DESCRIPTION OF THE DRAWINGS

While the specification concludes with claims particularly pointing out and distinctly claiming the subject matter, which is regarded as forming the present invention, the invention will be better understood from the following description taken in conjunction with the accompanying drawing.

FIG. 1 is a plan view of an exemplary container according to the disclosure.

### DETAILED DESCRIPTION

The present invention discloses compositions of phthalate-free plasticizers including dioctyl terephthalate (DEHT) and epoxidized vegetable oils, for compounding in thermoplastic polymer compositions, especially in thermoplastic polymer compositions comprising PVC. Generally, such plasticized PVC-containing compositions are used to form films and may advantageously be used to form bags for medical use, including but not limited to intravenous (IV) infusion, blood transfusion, and dialysis. The plasticized PVC-containing compositions can surprisingly and advantageously demonstrate similar or even improved physical properties relative to comparable PVC compositions containing DEHP.

The plasticizer compositions disclosed herein include mixtures comprising DEHT and an epoxidized vegetable oil. The plasticizer compositions disclosed herein typically contain DEHT in further combination with either epoxidized soybean oil or epoxidized linseed oil.

The plasticizer compositions disclosed herein can include mixtures of DEHT and epoxidized linseed oil in a weight ratio of between about 2.5:1 (DEHT:epoxidized linseed oil) and about 20:1, between about 3.5:1 and about 17.5:1, between about 5:1 and about 15:1, between about 5:1 and about 10:1, for example, the ratio of DEHT to epoxidized linseed oil can be about 7.5:1.

The plasticizer compositions disclosed herein can include mixtures of DEHT and epoxidized soybean oil in a weight ratio of between 7.5:1 (DEHT:epoxidized soybean oil) and about 30:1, between about 10:1 and about 25:1, between about 12.5:1 and about 25:1, for example, the ratio of DEHT to epoxidized soy bean oil can be about 17.6:1.

The plasticizer compositions disclosed can be further incorporated into plastics to provide plasticized compositions. The plastic is typically a thermoplastic polymer. Thermoplastic polymers are generally defined as polymers which become moldable above a specific temperature, and become rigid as they cool. Examples of thermoplastic polymers include polyvinyl chlorides (PVCs), polyolefins, polyesters, and polystyrenes. Some thermoplastic polymers may become brittle upon cooling. Plasticizer compositions are typically added to the thermoplastic polymer in order to improve the mechanical properties of the plasticized thermoplastic composition compared with the unplasticized composition. In embodiments, the polymer of the plasticized composition is a thermoplastic polymer. In some embodiments, the polymer of the plasticized composition is polyvinyl chloride.

In some embodiments, a plasticized composition comprises a thermoplastic polymer and between about 1.75 to about 6.0 weight percent (“wt %”), about 2.0 to about 5.5 wt %, about 2.5 to about 5.0 wt %, and/or about 3.0 to about 4.5 wt % epoxidized linseed oil, based on the total weight of the plasticized composition, and an amount of DEHT, which in combination with the epoxidized linseed oil is sufficient to plasticize the thermoplastic polymer and advantageously can provide the plasticized composition with mechanical properties that are generally comparable and may even be surprisingly superior to a corresponding plasticized composition containing DEHP in a similar amount. The plasticized composition may comprise between about 22 to about 28 wt %, about 23 to about 27 wt %, about 24 to about 26.5 wt %, and/or about 24.5 to about 26 wt % DEHT, based on the total weight of the plasticized composition. The plasticized composition may comprise a total (i.e., including DEHT and epoxidized linseed oil) plasticizer concentration of between 23.75 to about 34 wt %, about 25 to about 32.5 wt. %, about 27 to about 31 wt. %, and/or about 27.5 to about 30.5 wt %, based on the total weight of the plasticized composition.

In other embodiments, a plasticized composition comprises a thermoplastic polymer and between about 0.5 to about 3.0 wt %, about 1 to about 2 wt %, and/or about 1.25 to about 1.75 wt % epoxidized soybean oil, based on the total weight of the plasticized composition, and an amount of DEHT, which in combination with the epoxidized soybean oil is sufficient to plasticize the thermoplastic polymer and advantageously can provide the plasticized composition with mechanical properties that are generally comparable and may even be surprisingly superior to a corresponding plasticized composition containing DEHP in a similar amount. The plasticizer composition may comprise about 25 to about 30 wt %, about 26 to about 29 wt %, and/or about 27 to about 28 wt % DEHT, based on the total weight of the plasticized composition. The plasticizer composition may comprise a total (i.e. including DEHT and epoxidized soy bean oil) plasticizer concentration of between about 25.5 to about 33 wt %, about 26 to about 31 wt %, and/or about 27 to about 30 wt %, based on the total weight of the plasticized composition.

The plasticizer compositions as well as the plasticized compositions disclosed herein are typically substantially free of phthalates including but not limited to DEHP, butyl benzyl phthalate (BBzP), dibutyl phthalate (DnBP), diethyl phthalate (DEP), di-butyl phthalate (DBP), benzyl butyl phthalate (BBP), diisobutyl phthalate (DiBP), diisononyl phthalate (DiNP), di-n-octyl phthalate (DnOP), dipentyl phthalate (DPP), di-isobutyl phthalate (DiBP), di-isononyl phthalate (DiNP), di-isohexyl phthalate, dicyclohexyl phthalate (DcHP), and di-isoheptyl phthalate.

As used herein, “substantially free of” means that the plasticizer composition or plasticized thermoplastic composition comprising DEHT and epoxidized soybean or epoxidized linseed oil contains insignificant amounts of the indicated component. For example, the formulation of the plasticizer compositions disclosed herein may contain less than 2.5 wt %, less than 2 wt %, less than 1.5 wt %, less than 1 wt %, less than 0.5 wt %, less than 0.1 wt %, more preferably less than 0.05 wt %, based on the weight of the composition, of phthalates (overall), and/or of particular specific phthalates such as DEHP, or another indicated component.

As used herein, the term “about” means+/−10% of any recited value, or in an alternative embodiment, +/−5% of any recited value. As used herein, this term modifies any recited value, range of values, or endpoints of one or more ranges.

The disclosed plasticized compositions comprising a plastic, typically a thermoplastic polymer such as PVC, may further include other additives. Suitable additives are chemical additives which may be added to polymers to inhibit or retard their degradation from processes such as oxidation, UV-damage, thermal degradation, or to enhance lubrication, etc. Exemplary additives include but are not limited to polypropylene glycol epoxidized esters as a processing aid to assist with processing, zinc stearate as a heat stabilizer, and high density polyethylene (HDPE) as a lubricant. In embodiments, the amount of polypropylene glycol epoxidized esters is between about 6.0 to about 12.0 wt %, between about 7 to about 11 wt %, between about 8.0 to about 10.0 wt %, based on the total weight of the plasticized composition. In embodiments, the amount of zinc stearate is between about 0.02 to about 0.20 wt %, between about 0.05 to about 0.10 wt %, between about 0.05 to about 0.075 wt. %, based on the total weight of the plasticized composition. In embodiments, the amount of HDPE is between about 0.005 and about 0.05 wt %, between about 0.0075 and about 0.04 wt %, between about 0.01 and about 0.03 wt %, based on the total weight of the plasticized composition.

In some embodiments, a plasticized thermoplastic composition comprises a thermoplastic polymer, typically PVC, and a plasticizer composition as disclosed herein. The plasticized thermoplastic composition typically comprises a concentration of plasticizer of about 40 to about 55 parts per hundred resin (phr), the plasticizer composition comprising about 3 to about 9 phr of epoxidized linseed oil and about 37 to about 46 phr DEHT. In embodiments, the plasticized composition further comprises an amount of polypropylene glycol epoxidized esters between about 10 to about 20 phr. In embodiments, the plasticized composition further comprises an amount of zinc stearate between about 0.05 to about 0.15 phr. In embodiments, the plasticized composition further comprises an amount of HDPE between about 0.02 to about 0.03 phr.

In some embodiments, a plasticized thermoplastic composition comprises a thermoplastic polymer, typically PVC, and a plasticizer composition, as disclosed herein. The plasticized thermoplastic composition typically comprises a plasticizer composition concentration of about 40 to about 55 phr, the plasticizer composition comprising about 1 to about 4 phr of epoxidized soybean oil and about 39 to about 51 phr DEHT. In embodiments, the plasticized composition further comprises an amount of polypropylene glycol epoxidized esters between about 10 to about 20 phr. In embodiments, the plasticized composition further comprises an amount of zinc stearate between about 0.05 to about 0.15 phr. In embodiments, the plasticized composition further comprises an amount of HDPE between about 0.02 to about 0.03 phr.

In one embodiment, a multilayer flexible sheet layer (or film) comprising a plasticized thermoplastic composition as disclosed herein is used to manufacture a container. In one aspect according to this embodiment, the multilayer flexible sheet layer comprises a plasticized thermoplastic polymer composition as described above. The flexible sheet layer may have any suitable thickness, for example, between about 100 μm and about 250 μm, between about 125 μm and about 225 μm, and/or between about 150 μm and about 200 μm.

Suitable containers include flexible bags as disclosed in US 2008/0249499, which is hereby incorporated by reference in its entirety. The flexible bag may be formed by any of a number of methods, for example, by an exemplary form/fill/seal process where a sheet layer (or film) is aligned and then folded by a folding triangle. After that aligning and folding step, the film can be cut to allow the introduction of a port system (described below) between the two resulting facing films. The port system can then be automatically fed in place and welded between the two opposing faces of the folded film. By vertical welding the bottom part of the bag is formed and a hanger hole is punched. The side of the bag is formed by horizontal welding, while the solution for infusion is fed into the formed flexible bag. The upper horizontal welding also can form the lower side of the next bag. Finally, each bag is separated from the other during a sealing/cutting process. Thus, the flexible bag may be formed of a single film or sheet layer of flexible material, folded and sealed along the peripheral edges.

In other methods, two flexible films or sheets are joined at a top end and two side edges, i.e., when the two flexible sheets are placed in facing relationship they can be joined at their overlying/overlapping peripheral edges, while leaving an opening at a bottom end. The sealed top end and side edges, along with the open bottom end, are collectively referred to herein as the peripheral edges of the flexible bag. The top end generally includes a hanger aperture, which is preferably laterally offset from a central vertical axis of the flexible bag portion. The port system can then be fed in place and welded between the two opposing flexible sheets. Any other known method of bag manufacture, such as blow molding or vacuum forming, may also be used.

Such flexible bags necessarily include an administration port. In one embodiment, the primary container is a flexible bag with a single port adapted for fluid delivery (internally or externally), the single port comprising an administration port for delivering formulations to a patient via connection to an administration set. Because the primary container includes a ready-to-use formulation therein, the primary container according to this embodiment does not require, but may include a separate functioning “injection” or “reconstitution” port that allows a fluid to be added to the formulation of the primary container, or may instead include a non-accessible “dummy” port that does not include a frangible cannula or pierceable diaphragm or membrane and thus does not readily allow for communication between an interior of the primary container and the exterior. A “dummy” port is not considered to be a port as conventionally understood as it does not function to provide access to the contents of the primary container. The dummy port may be substantially solid. The dummy port may be configured to prevent at least 90% of attempts to insert a standard 21 gauge needle at an insertion rate of 200 mm/min into the interior of the primary container using an insertion force of 5N or less, or even 10 N or less.

The port structure is preferably sized and configured to fit within the opening (not illustrated) in the bottom end of the bag. In a preferred embodiment, the opening and port structure are substantially as wide as the top edge, such that the port structure essentially defines the entire bottom surface of the bag. The port structure is formed of a plastic material that in the preferred embodiment is less flexible than the bag portion and is preferably molded as a single, integral unit. In this respect, the preferred port structure may be considered as having intermediate rigidity, as it is preferably more rigid than the generally flexible bag, but less than rigid than materials such as glass or metal. The port structure typically includes a single functioning port as mentioned above.

In one embodiment, the port structure is molded from polyethylene (PE). The molded port system includes an administration port, which allows access to the bag contents, and optionally may further include either a non-accessible (dummy) port, which prevents addition of medication or diluent, or a functioning “injection” or “reconstitution” port that allows a fluid to be added to the formulation of the bag. The administration port may have a twist-off protective cap and a membrane in addition to a flexible sleeve. The twist off protector and the membrane may comprise PE. The flexible sleeve typically provides a non-dripless access connector (non-DAC) port configuration and in one embodiment may comprise a coextruded inner layer and outer layer.

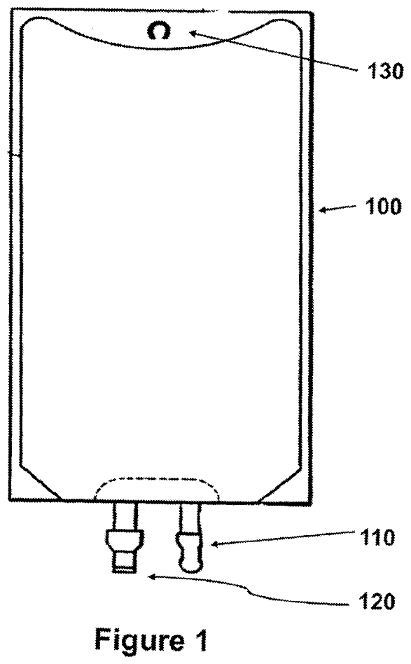

FIG. 1 illustrates a suitable container 100 according to the disclosure. As illustrated, the container is a plastic bag with a single functioning port 110. The single port 110 is an administration port for delivering the contents to a subject. The administration port 110 is fluidly connected to a contents of the container 100 via a flexible sleeve defining a channel capable of fluid communication with the contents of the container. The container 100 also may include an optional non-accessible (dummy) port 120, which may be solid to prevent addition of medication or diluent. Alternatively, port 120 may be a reconstitution port that allows a fluid to be added to the formulation of the primary container. The primary container 100 further includes a hanger hole 130.

In part because of the advantageous mechanical properties of the films disclosed herein, while advantageously preferably being substantially free of DEHP, the plastic bag disclosed herein is particularly adapted and arranged to be used for delivery of a medicament as an intravenous infusion (i.e., as an IV bag), for blood transfusions (i.e., as an IV bag), or for delivery of a dialysis solution, also called dialysate (i.e., as a dialysate bag).

In one particular embodiment, the plastic bag disclosed in the present application may be advantageously used in peritoneal dialysis. Peritoneal dialysis bags include a dialysate which is infused into a patient's peritoneal cavity via a catheter and is typically exchanged four to six times every day. As a result, the patient can be subjected to elevated levels of DEHT, which may be harmful. Thus, the dialysis bags according to the instant disclosure, which are substantially free of DEHT, and formed of a plastic film, typically comprising a PVC blend, are particularly disadvantageous in that they can greatly reduce a patient's exposure to DEHT, which can accumulate in tissues over time. An exemplary dialysate solution contains glucose, dextrose (D-glucose), a glucose polymer (e.g., icodextrin), or a combination thereof and electrolytes. For electrolytes, at least sodium, calcium, magnesium, chloride, and bicarbonate ions are typically present in dialysate solutions. Potassium ions may also be present. For example, an exemplary dialysate solution comprises about 10 to about 50 g/L glucose, for example, 15.0 g/L, 25.0 g/L, or 42.5 g/L of glucose, about 4 to about 6 g/L sodium chloride, for example, 5.4 g/L of sodium chloride, about 1 to about 2.5 sodium lactate, for example, 1.7 g/L of sodium lactate, about 10 to about 100 mg/L magnesium chloride, for example, 51 mg/L of magnesium chloride hexahydrate, about 100 to about 250 mg/L calcium chloride, for example, 184 mg/L of calcium chloride dihydrate, and about 1 to about 3 g/L sodium bicarbonate, for example, about 2.1 g/L of sodium bicarbonate. Examples of suitable dialysates include but are not limited to dialysate solutions sold under the Dianeal®, Extraneal®, Nutrineal®, and Physioneal® trade names (Baxter Healthcare Corporation, USA).

The following examples are provided to illustrate plasticized compositions according to the invention, but are not intended to limit the scope thereof.

### Examples

### Example 1—Epoxidized Linseed Oil Compositions

Plasticizer compositions including DEHT and epoxidized linseed oil and additives were compounded into a thermoplastic PVC polymer, from which flexible sheets or films were formed and tested. Table 1 shows DEHP-free plasticized compositions comprising PVC polymer compositions with varying concentrations of DEHT and epoxidized linseed oil. Table 2 shows tensile strength (“UTS”) and percent elongation of films prepared using the plasticized compositions described in table 1.

The plasticized film formed using the epoxidized linseed oil-containing plasticized composition 1A according to the invention displayed markedly improved ultimate tensile strength (UTS) and/or elongation % results relative to films formed using the other 7 comparative compositions (DEHP, DEHT, 1B, 1C, 1D, 1E, and 1F). The plasticized film formed using composition 1A exhibited an average UTS of 17.73 MPa, with an elongation percentage of 257.83%, which represent surprisingly improved mechanical properties, when compared with a film plasticized with the state of the art plasticizer DEHP (Ref. Film DEHP) which displayed an average UTS of 15.77 MPa and 198.15% elongation, and film plasticized with the primary component of formulation 1A, DEHT (Ref. Film DEHT), which displayed an average UTS of 13.43 MPa and 240.38% elongation. These results demonstrate an unexpected and surprising improvement in both UTS and elongation % of films plasticized with a combination of epoxidized linseed oil and DEHT relative to films plasticized with DEHP and DEHT. These results are especially surprising in view of our finding that plasticized films comprising a comparable concentration of DEHT does not perform remotely similarly to the film plasticized with the combination of DEHT and epoxidized linseed oil of composition 1A.

The effect of varying epoxidized linseed oil concentrations from 0 to 25 phr in combination with a corresponding varied amount of DEHT, such that the total amount of plasticizer is not greater than 46.5 phr, are also shown in table 2. Epoxidized linseed oil concentrations of 2.5 or lower, such as compositions 1B and 1C, show significantly reduced elongation % than observed for the 1A composition. Interestingly, as epoxidized linseed oil concentration is further increased beyond 5.5 phr, as in composition 1D (10 phr), UTS and elongation % both significantly decreased. For example, composition 1 E comprises 20 phr of epoxidized linseed oil, but a significantly lower UTS of 11.9 MPa. These results highlight the surprisingly and unexpectedly enhanced mechanical properties of the 1A composition compared to the comparative compositions, particularly to comparative compositions (1C, 1D, 1E, and 1F) plasticized with the same components but in different amounts.

TABLE 1
Epoxidized Linseed Oil Compositions

| | Ref. Film | Ref. Film | Films with Epoxidized Linseed Oil | | | | | |
|---|---|---|---|---|---|---|---|---|
| Components | (DEHP) | (DEHT) | 1B | 1C | 1A | 1D | 1E | 1F |
| PVC | 100 | 100 | 100 | 100 | 100 | 100 | 100 | 100 |
| DEHP | 44 | 0 | 0 | 0 | 0 | 0 | 0 | 0 |
| DEHT | 0 | 46.5 | 44 | 44 | 41 | 35 | 25 | 20 |
| Polypropylene Glycol | 14.5 | 14.5 | 14.5 | 14.5 | 14.5 | 14.5 | 14.5 | 14.5 |
| Epoxidized ester | | | | | | | | |
| Lubricant (HDPE) | 0.025 | 0.025 | 0.025 | 0.025 | 0.025 | 0.025 | 0.025 | 0.025 |
| Zn Stearate | 0.1 | 0.1 | 0.1 | 0.1 | 0.1 | 0.1 | 0.1 | 0.1 |
| Epoxidized Linseed oil | 0 | 0 | 0 | 2.5 | 5.5 | 10 | 20 | 25 |
| Epoxidized Soybean Oil | 0 | 0 | 0 | 0 | 0 | 0 | 0 | 0 |
| Total | 158.625 | 161.13 | 158.63 | 161.13 | 161.13 | 159.63 | 159.63 | 159.63 |

TABLE 2
Epoxidized Linseed Oil Composition Tensile Testing Results

| | | Reference | Reference | Films with Epoxidized Linseed Oil | | | | | |
|---|---|---|---|---|---|---|---|---|---|
| Samples/Properties | | Film (DEHP) | Film (DEHT) | 1B | 1C | 1A | 1D | 1E | 1F |
| S1 | UTS (MPa) | 17.36 | 14.7 | 12.9 | 22.7 | 17.7 | 7.5 | 12.1 | 13.6 |
| | Elongation | 263.3 | 273.2 | 254.2 | 172.4 | 279 | 106.4 | 209.4 | 207.7 |
| | % | | | | | | | | |
| S2 | UTS (MPa) | 15.2 | 16.6 | 16.78 | 21.21 | 18.1 | 12.89 | 12.1 | 7.5 |
| | Elongation | 155.7 | 295.1 | 234.6 | 158.1 | 228 | 109.8 | 209.5 | 97.9 |
| | % | | | | | | | | |
| S3 | UTS (MPa) | 15.2 | 12.1 | 12.2 | 19.52 | 17.5 | 10.1 | 10.1 | 10.2 |
| | Elongation | 187.7 | 238 | 92.4 | 143.2 | 249.8 | 116.3 | 140 | 114.4 |
| | % | | | | | | | | |
| S4 | UTS (MPa) | 15.3 | 10.3 | 12.2 | 17.2 | 17.6 | 9.7 | 13.3 | 15.2 |
| | Elongation | 185.9 | 155.2 | 109.8 | 90.29 | 274.5 | 137.8 | 242.8 | 239.1 |
| | % | | | | | | | | |
| Avg. | UTS (MPa) | 15.77 | 13.43 | 13.52 | 20.16 | 17.73 | 10.05 | 11.9 | 11.63 |
| | Elongation | 198.15 | 240.38 | 172.75 | 141 | 257.83 | 117.58 | 200.43 | 164.78 |
| | % | | | | | | | | |

### Example 2—Epoxidized Soybean Oil Compositions

Plasticizer compositions including DEHT and epoxidized soybean oil and additives were compounded into a thermoplastic PVC polymer, from which flexible sheets or films were formed and tested. Table 3 shows DEHP-free plasticized compositions comprising PVC polymer compositions with varying concentrations of DEHT and epoxidized soybean oil. Table 4 shows tensile strength (“UTS”) and percent elongation of films prepared using the plasticized compositions described in table 3.

The plasticized film formed using the epoxidized linseed oil-containing plasticizer composition 2A according to the invention displayed markedly different ultimate tensile strength (UTS) and/or elongation % results relative to films formed using the other 6 comparative compositions (DEHP, DEHT, 2B, 2C, 2D, and 2E). The plasticized film formed using composition 2A exhibited an average UTS of 19.63 MPa, with an elongation percentage of 312.7%, which represent surprisingly improved mechanical properties, when compared with a film plasticized with the state of the art plasticizer DEHP (Ref. Film DEHP) which displayed an average UTS of 15.77 MPa and 198.15% elongation, and film plasticized with the primary component of formulation 2A, DEHT (Ref. Film DEHT), which displayed an average UTS of 13.43 MPa and 240.38% elongation. These results demonstrate an unexpected and surprising improvement in both UTS and elongation % of films plasticized with a combination of epoxidized soybean oil and DEHT relative to films plasticized with DEHP and DEHT. These results are especially surprising in view of our finding that plasticized films comprising a comparable concentration of DEHT does not perform remotely similarly to the film plasticized with the combination of DEHT and epoxidized soybean oil of composition 2A.

The effect of varying epoxidized soybean oil concentrations from 0 to 25 phr in combination with a corresponding amount of DEHT, such that the total amount of plasticizer is not greater than 46.5 phr, are also shown in table 3. Interestingly, as epoxidized soybean oil concentration is further increased beyond 2.5 phr, as in composition 2B (5.5 phr), UTS and elongation %, decreased. For example, composition 2C comprises 10 phr of epoxidized soybean oil, but a lower UTS of 9.23 MPa. These results highlight the surprising and unexpected mechanical properties of the 2A composition compared to the 6 comparative compositions, including compositions plasticized with the same components but in different amounts.

TABLE 3
Epoxidized Soybean Oil Compositions

| | Ref. Film | Ref. Film | Films with Epoxidized Soybean Oil | | | | |
|---|---|---|---|---|---|---|---|
| Components/Formulations | (DEHP) | (DEHT) | 2A | 2B | 2C | 2D | 2E |
| PVC | 100 | 100 | 100 | 100 | 100 | 100 | 100 |
| DEHP | 44 | 0 | 0 | 0 | 0 | 0 | 0 |
| DEHT | 0 | 46.5 | 44 | 41 | 35 | 25 | 20 |
| Polypropylene Glycol | 14.5 | 14.5 | 14.5 | 14.5 | 14.5 | 14.5 | 14.5 |
| Epoxidized ester | | | | | | | |
| Lubricant (HDPE) | 0.025 | 0.025 | 0.025 | 0.025 | 0.025 | 0.025 | 0.025 |
| Zn Stearate | 0.1 | 0.1 | 0.1 | 0.1 | 0.1 | 0.1 | 0.1 |
| Epoxidized Linseed oil | 0 | 0 | 0 | 0 | 0 | 0 | 0 |
| Epoxidized Soybean Oil | 0 | 0 | 2.5 | 5.5 | 10 | 20 | 25 |
| Total | 158.625 | 161.13 | 161.13 | 161.13 | 159.63 | 159.63 | 159.63 |

TABLE 4
Epoxidized Soybean Oil Composition Tensile Testing Results

| | | Reference | Reference | Films with Epoxidized Soybean Oil | | | | |
|---|---|---|---|---|---|---|---|---|
| Samples/Properties | | Film (DEHP) | Film (DEHT) | 2A | 2B | 2C | 2D | 2E |
| S1 | UTS (MPa) | 17.36 | 14.7 | 21 | 15.1 | 6.3 | 9 | 13 |
| | Elongation % | 263.3 | 273.2 | 367.2 | 207 | 56.1 | 90.3 | 78.8 |
| S2 | UTS (MPa) | 15.2 | 16.6 | 21.5 | 14.7 | 10.2 | 10.8 | 13.4 |
| | Elongation % | 155.7 | 295.1 | 329.6 | 222.4 | 85.8 | 101.6 | 94.6 |
| S3 | UTS (MPa) | 15.2 | 12.1 | 18.4 | 13.3 | 12.2 | 12.2 | 15.4 |
| | Elongation % | 187.7 | 238 | 271.8 | 205 | 160.15 | 120.4 | 224.1 |
| S4 | UTS (MPa) | 15.3 | 10.3 | 17.6 | 14 | 8.2 | 13.4 | 15.6 |
| | Elongation % | 185.9 | 155.2 | 282.2 | 214.7 | 81.3 | 196.2 | 258.5 |
| Avg. | UTS (MPa) | 15.77 | 13.43 | 19.63 | 14.28 | 9.23 | 11.35 | 14.35 |
| | Elongation % | 198.15 | 240.38 | 312.7 | 212.28 | 95.84 | 127.13 | 164 |

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A plasticized composition comprising a thermoplastic polymer and a combination of plasticizers comprising dioctyl terephthalate (DEHT) and epoxidized linseed oil, wherein the concentration of the epoxidized linseed oil is in the range of about 1.75 to about 6.0 wt %, and the total concentration of dioctyl terephthalate and epoxidized linseed oil is in the range of about 23.75 to about 34 wt %, based on the total weight of the plasticized composition.

2. The plasticized composition of claim 1, wherein DEHT is present in an amount between about 22 to about 28 wt %, based on the total weight of the plasticized composition.

3. A plasticized composition comprising a thermoplastic polymer and a combination of plasticizers comprising dioctyl terephthalate (DEHT) and epoxidized soybean oil, wherein the concentration of the epoxidized soybean oil is in the range of range of about 0.5 to about 3.0 wt %, and the total concentration of dioctyl terephthalate and epoxidized soybean oil is in the range of about 25.5 to about 33 wt %, based on the total weight of the plasticized composition.

4. The plasticized composition of claim 3, where in the concentration of DEHT about 25 to about 30 wt based on the total weight of the plasticized composition.

5. The plasticized composition of claim 1, wherein the thermoplastic polymer comprises polyvinyl chloride.

6. The plasticized composition of claim 1, wherein the plasticized composition is substantially free of phthalates.

7. The plasticized composition of claim 1, further comprising polypropylene glycol epoxidized esters in an amount between about 6.0 to about 12.0 wt %, based on the total weight of the plasticized composition.

8. The plasticized composition of claim 1, further comprising zinc stearate in an amount between about 0.02 to about 0.20 wt % based on the total weight of the plasticized composition.

9. The plasticized composition of claim 1, further comprising high density polyethylene (HDPE).

10. A film comprising the plasticized composition according to claim 1.

11. A plastic bag comprising the film according to claim 10.

12. The plastic bag according to claim 11 further comprising a dialysate solution.

13. The bag of claim 12, wherein the dialysate solution comprises glucose, dextrose, a glucose polymer, or a combination thereof, and electrolytes.

14. The bag of claim 12, wherein the dialysate solution further comprises sodium, calcium, magnesium, chloride, and bicarbonate ions.
